(19) United States
(12) Patent Application Publication
(10) Pub. No.: US 2015/0334572 A1
(43) Pub. Date: Nov. 19, 2015

(54) RADIO ACCESS NETWORK APPARATUS, MOBILE COMMUNICATION SYSTEM, COMMUNICATION METHOD, AND NON-TRANSITORY COMPUTER READABLE MEDIUM STORING PROGRAM

(71) Applicant: NEC CORPORATION, Tokyo (JP)

(72) Inventor: Masaki NAKAI, Tokyo (JP)

(73) Assignee: NEC Corporation

(21) Appl. No.: 14/429,579

(22) PCT Filed: May 13, 2013
(86) PCT No.: PCT/JP2013/003054

§ 371 Date: Mar. 19, 2015

(30) Foreign Application Priority Data
Sep. 28, 2012 (JP) 2012-215353

(51) Int. Cl. H04W 12/12; H04W 76/04

(52) U.S. Cl. CPC H04W 12/12; H04W 76/046

(57) ABSTRACT

A radio access network apparatus (20) includes: first receiving unit (21) for receiving a radio control connection setup request signal transmitted by a mobile station that establishes a radio control connection; first transmitting unit (22) for transmitting a radio control connection setup signal to the mobile station, which has transmitted the radio control connection setup request signal; second receiving unit (23) for receiving a radio control connection setup complete signal transmitted by the mobile station, which has received the radio control connection setup signal; and allocating unit (25) for allocating, in a memory (24), a storage area for storing therein context information necessary for communication with the mobile station upon receiving the radio control connection setup complete signal.

### TECHNICAL FIELD

The present invention relates to a radio access network apparatus, a mobile communication system, a communication method, and a non-transitory computer readable medium storing a program.

### BACKGROUND ART

In wired networks such as the Internet, etc., it is known that malicious attacks called Denial of Service (DoS) attacks have been made. Among DoS attacks, there is an attack to increase the traffic on the network thus to occupy the processing capacity (resources) of lines and the server performing a communication process, and thereby to attempt to make the system difficult to use and/or to make the system go down. In recent years, countermeasures against DoS attacks in radio networks have been also studied (Patent Literature 1).

Meanwhile, as illustrated in FIG. 3, a mobile communication system of LTE (Long Term Evolution) specified by 3GPP (Third Generation Partnership Project) includes mobile stations (UEs: User Equipments), base stations (evolved Nodes B (eNBs)), which are radio access network apparatuses, and a core network. Between the UE 100 and the eNB 200, during a call connection, a radio control connection is established by using RRC (Radio Resource Control), which is a protocol in L3 (Layer 3) (Non Patent Literature 1).

FIG. 8 is a sequence diagram of an RRC message to be transmitted/received between the UE 100 and the eNB 200 when a radio control connection is established. First, the UE 100 transmits, to the eNB 200, an RRC Connection Request message, which is a radio control connection request signal (S100). The eNB 200, which has received the message, transmits, to the UE 100, an RRC Connection Setup message, which is a radio control connection setup signal (S101). The UE 100, which has received the message, transmits an RRC Connection Setup Complete message, which is a radio control connection setup complete signal (S102).

### CITATION LIST

### Patent Literature

Patent Literature 1: Published Japanese Translation of PCT International Publication for Patent Application, No. 2008-537385

### Non Patent Literature

Non Patent Literature 1: Evolved Universal Terrestrial Radio Access (E-UTRA); Radio Resource Control (RRC); Protocol specification [3GPP TS36.331 V10.4.0]

### SUMMARY OF INVENTION

### Technical Problem

There are the following problems in the above-described background technologies. When establishing a radio control connection in the sequence illustrated in FIG. 8, the eNB 200 is required to allocate, in a memory, a storage area for storing context information (UE Context), which is information necessary for performing communication with the UE 100.

There is now assumed as illustrated in FIG. 9 the case where DoS attacks have been made such that a malicious UE 120 transmits an RRC Connection Request (S200, S203), but does not respond to an RRC Connection Setup (S202, S205) transmitted from the eNB 200 so that operations that do not properly complete the sequence are repeated one after another. In this case, UE Context storage areas in the eNB200 are successively allocated (S201, S204) one after another so that the UE Context storage areas would be eventually depleted (S206). This causes such a problem that even if a normal UE 110 transmits an RRC Connection Request (S207), the eNB 200 fails to allocate UE Context storage areas for UE110 so that the UE 110 cannot properly perform communication.

In view of the above, an object of the present invention is to provide a radio access network apparatus, a mobile communication system, a communication method, and a non-transitory computer readable medium storing a program, which are less susceptible to DoS attacks.

### Solution to Problem

A radio access network apparatus according to the present invention is a radio access network apparatus comprising:

first receiving means for receiving a radio control connection setup request signal transmitted by a mobile station that establishes a radio control connection;

first transmitting means for transmitting a radio control connection setup signal to the mobile station, which has transmitted the radio control connection setup request signal;

second receiving means for receiving a radio control connection setup complete signal transmitted by the mobile station, which has received the radio control connection setup signal; and

allocating means for allocating, in a memory, a storage area for storing therein context information necessary for communication with the mobile station upon receiving the radio control connection setup complete signal.

A communication method according to the present invention is a communication method comprising:
receiving a radio control connection setup request signal transmitted by a mobile station that establishes a radio control connection between the mobile station and a radio access network apparatus;
transmitting a radio control connection setup signal to the mobile station, which has transmitted the radio control connection setup request signal;
receiving a radio control connection setup complete signal transmitted by the mobile station, which has received the radio control connection setup signal; and
allocating, in a memory, a storage area for storing therein context information necessary for communication with the mobile station upon receiving the radio control connection setup complete signal.

A non-transitory computer readable medium according to the present invention is a non-transitory computer readable medium storing a program that causes a computer to execute:

a process of receiving a radio control connection setup request signal transmitted by a mobile station;

a process of transmitting a radio control connection setup signal to the mobile station, which has transmitted the radio control connection setup request signal;

a process of receiving a radio control connection setup complete signal transmitted by the mobile station, which has received the radio control connection setup signal, and

a process of allocating, in a memory, a storage area for storing context information necessary for communication with the mobile station upon receiving the radio control connection setup signal.

A mobile communication system according to the present invention is a mobile communication system comprising:

a mobile station; and

a radio access network apparatus that establishes a radio control connection between the radio access network apparatus and the mobile station,

the radio access network apparatus comprising:

first receiving means for receiving a radio control connection setup request signal transmitted by the mobile station;

first transmitting means for transmitting a radio control connection setup signal to the mobile station, which has transmitted the radio control connection setup request signal;

second receiving means for receiving a radio control connection setup complete signal transmitted by the mobile station, which has received the radio control connection setup signal, and

allocating means for allocating, in a memory, a storage area for storing therein context information necessary for communication with the mobile station upon receiving the radio control connection setup complete signal,

the mobile station comprising:

second transmitting means for transmitting the radio control connection setup request signal to the radio access network apparatus;

third receiving means for receiving the radio control connection setup signal from the radio access network apparatus, and third transmitting means for transmitting the radio control connection setup complete signal to the radio access network apparatus.

A communication method according to the present invention is a communication method performed by a mobile communication system comprising a mobile station, and a radio access network apparatus that establishes a radio control connection between the radio access network apparatus and the user station, Wherein

the mobile station transmits a radio control connection setup signal to the radio access network apparatus,

the radio access network apparatus transmits a radio control connection setup signal to the mobile station, which has transmitted the radio control connection setup request signal,

the mobile station, which has received the radio control connection setup signal, transmits a radio control connection setup complete signal to the radio access network apparatus, and

the radio access network apparatus, which has received the radio control connection setup complete signal, allocates, in a memory, a storage area for storing therein context information necessary for communication with the mobile station.

### ADVANTAGEOUS EFFECTS OF INVENTION

In the radio access network apparatus according to the present invention, even in the case where a malicious mobile station has made DoS attacks in which the malicious mobile station transmits a large amount of radio control connection request signals to prevent the setup sequence for the radio control connection from being properly completed, the memory will not be depleted and normal mobile stations are thereby prevented from becoming unable to perform communication. Accordingly, it is possible to provide a radio access network apparatus, a mobile communication system, a communication method and a non-transitory computer readable medium storing a program, which are less susceptible to DoS attacks.

### BRIEF DESCRIPTION OF DRAWINGS

FIG. 1 is a diagram illustrating a configuration according to a first exemplary embodiment;

FIG. 2 is a sequence diagram showing an operation according to the first exemplary embodiment;

FIG. 3 is a diagram illustrating a configuration of a mobile communication system of LTE specified by 3GPP;

FIG. 4 is a diagram illustrating a configuration according to a second exemplary embodiment;

FIG. 5 is a sequence diagram showing an operation according to the second exemplary embodiment;

FIG. 6 is a diagram showing information that UE transmits to eNB in the second exemplary embodiment;

FIG. 7 is a diagram illustrating a configuration of a mobile communication system of 3G specified by 3GPP;

FIG. 8 is a message sequence diagram when a radio control connection is established; and

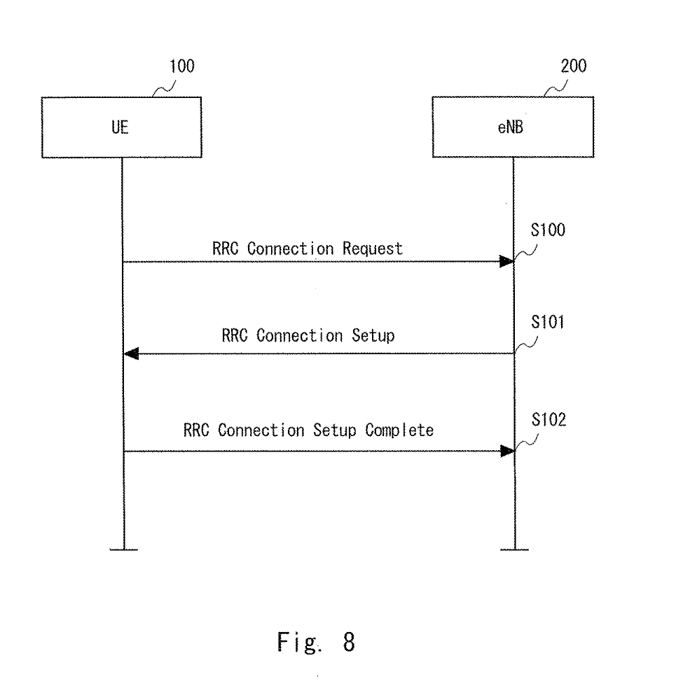

FIG. 9 is a sequence diagram in a case where DoS attacks are made.

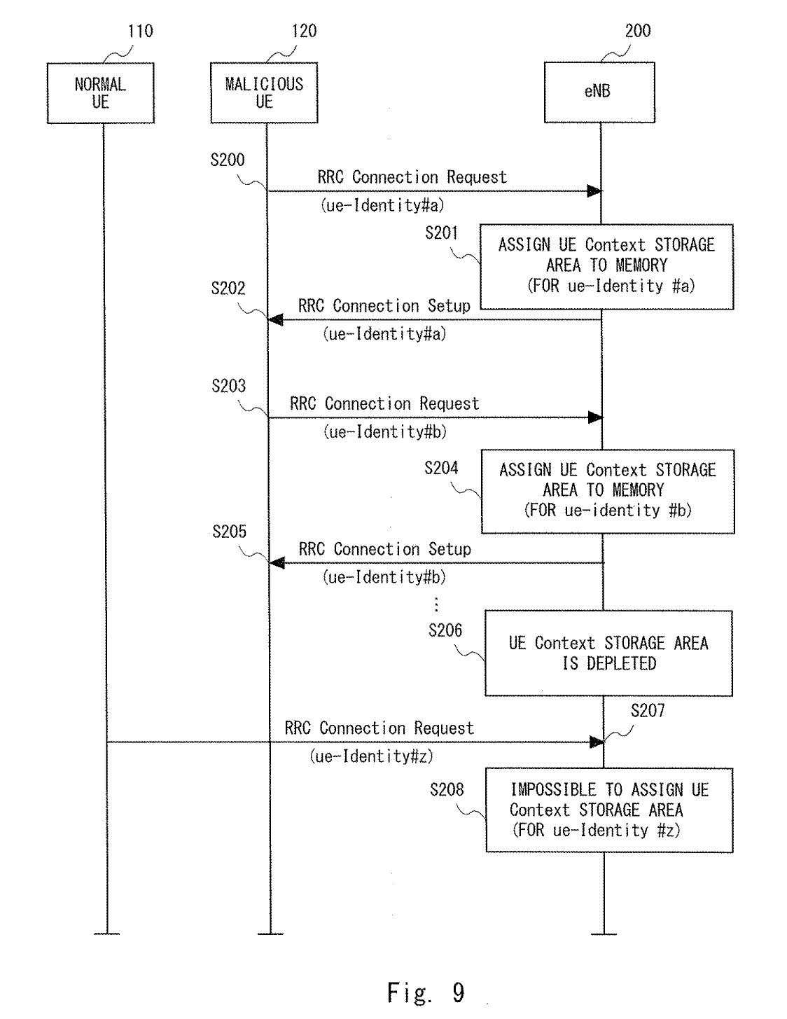

### DESCRIPTION OF EMBODIMENTS

Preferred exemplary embodiments for carrying out the present invention will be described hereinafter with reference to the attached drawings.

### First Exemplary Embodiment

### [Configuration]

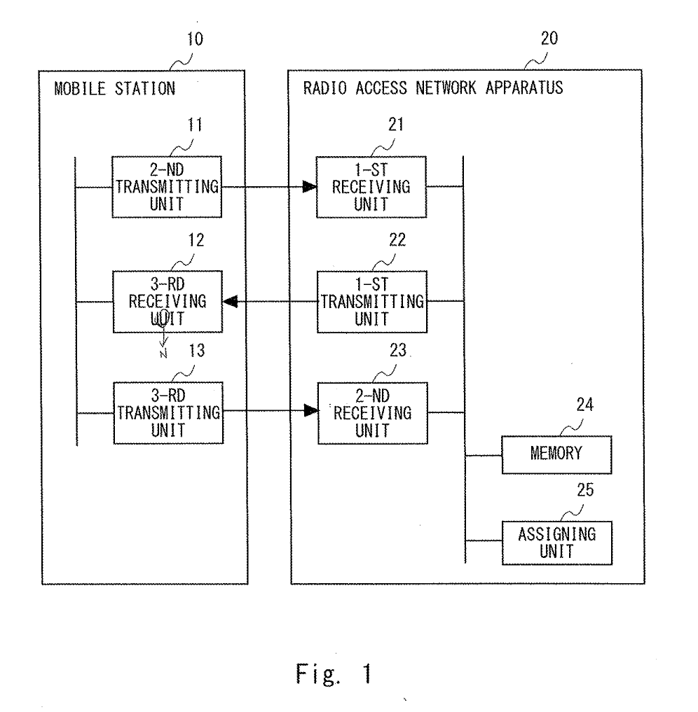

FIG. 1 is a diagram illustrating an example of a configuration according to a first exemplary embodiment. A mobile communication system according to the first exemplary embodiment includes a mobile station 10 and a radio access network apparatus 20 that establishes a radio control connection between the radio access network apparatus 20 and the mobile station 10.

The mobile station 10 includes a second transmitting unit 11 that transmits a radio control connection request signal to the radio access network apparatus 20, a third receiving unit 12 that receives a radio control connection setup signal from the radio access network apparatus 20, and a third transmitting unit 13 that transmits a radio control connection setup complete signal to the radio access network apparatus 20.

The radio access network apparatus 20 includes a first receiving unit 21 that receives a radio control connection request signal from the mobile station 10, a first transmitting unit 22 that transmits a radio control connection setup signal to the mobile station 10, and a second receiving unit 23 that receives a radio control connection setup complete signal from the mobile station 10. Moreover, the radio access network apparatus 20 includes a memory 24 and an allocating unit 25 that allocates, in the memory 24, a storage area for storing context information necessary for communication with the mobile station 10 upon receiving the radio control connection setup complete signal from the mobile station 10.

### [Operation]

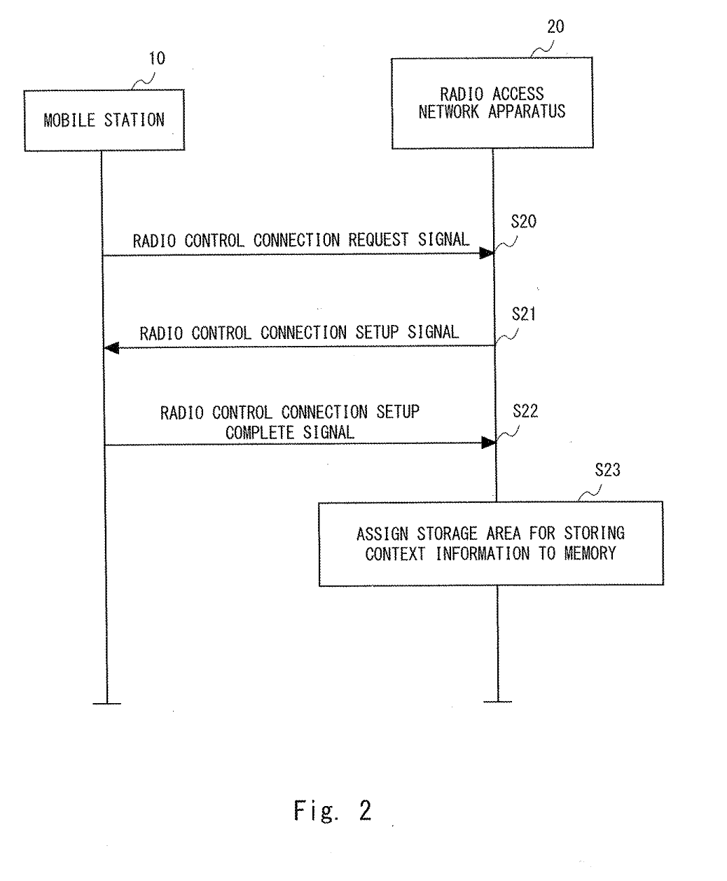

FIG. 2 is a sequence diagram showing an example of an operation in accordance with the first exemplary embodiment. The operation performed by the mobile station 10 and the radio access network apparatus 20 will be described hereinafter with reference to FIG. 2.

First, the mobile station 10 transmits a radio control connection request signal to the radio access network apparatus 20 (S20).

Next, the radio access network apparatus 20, which has received the radio control connection request signal, transmits a radio control connection setup signal to the mobile station 10 (S21).

Subsequently, the mobile station 10, which has received the radio control connection setup signal, transmits a radio control connection setup complete signal to the radio access network apparatus 20 (S22).

Further, the radio access network apparatus 20, which has received the radio control connection setup complete signal, determines that the mobile station 10 is not a malicious mobile station because of the fact that the operation of the step S22 is properly completed, and allocates, in the memory 24, a storage area for storing context information necessary for communication with the mobile station 10 (S23).

### [Advantageous Effects]

As described above, the radio access network apparatus according to this exemplary embodiment receives a radio control connection setup complete signal and after that allocates, in the memory, areas for storing context information necessary for communication with the mobile station. As a result, even in the case where a malicious mobile station has made DoS attacks in which the malicious mobile station transmits a large amount of radio control connection request signals to prevent the setup sequence for the radio control connection from being properly completed, the memory will not be depleted and normal mobile stations are thereby prevented from becoming unable to perform communication.

### Second Exemplary Embodiment

### [Configuration]

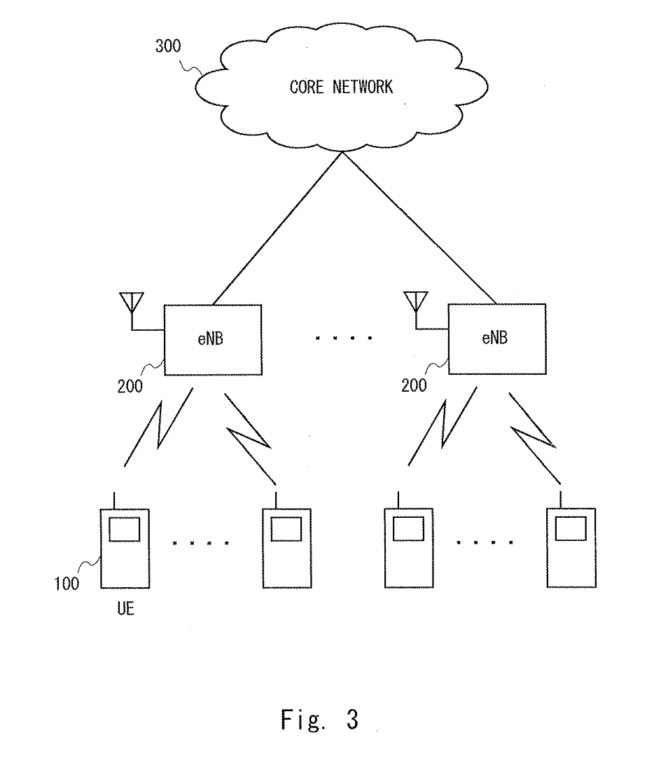

In the second exemplary embodiment, the invention according to the first exemplary embodiment is applied to a radio communication system of LTE illustrated in FIG. 3. Referring to FIG. 3, the mobile communication system according to the second exemplary embodiment includes UEs 100, eNBs 200 and a core network 300. The details of the configuration of the eNB 200, which is the main component of the present invention, will be described hereinafter with reference to the attached drawings.

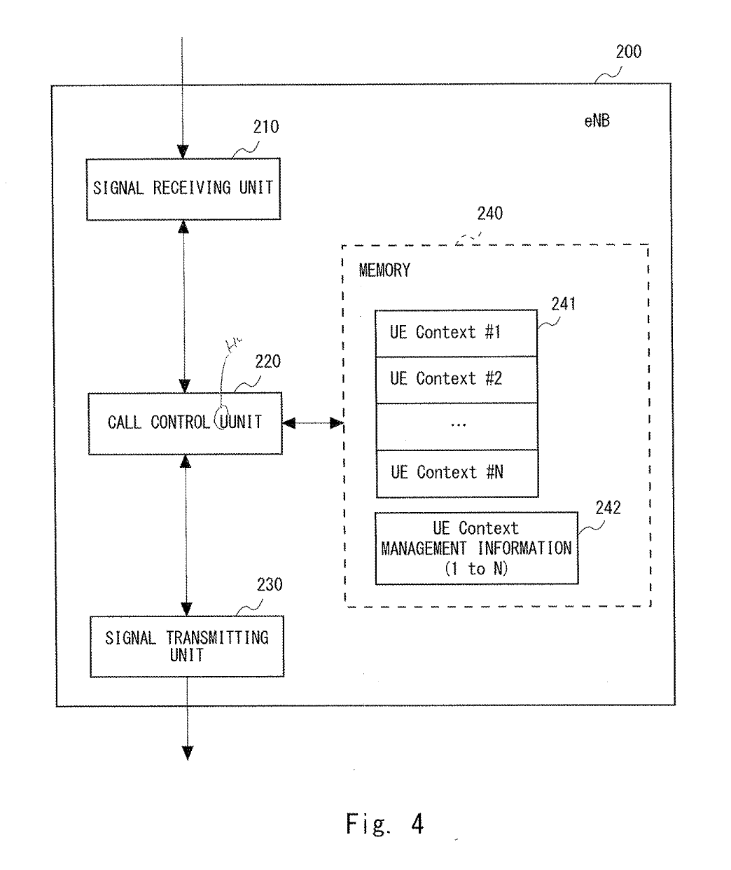

FIG. 4 is a diagram showing an example of a configuration of the eNB 200 according to the second exemplary embodiment. The eNB 200 includes a signal receiving unit 210, a call control unit 220, a signal transmitting unit 230, and a memory 240.

The signal receiving unit 210 receives a control signal in the form of a message from the UE 100 or the core network 300.

The signal transmitting unit 230 transmits a control signal in the form of a message to the UE 100 or the core network 300.

The call control unit 220 performs, based on the control signal received by the signal receiving unit 210, various call control processes required by the eNB 200, and performs control so as to allow the signal transmitting unit 230 to transmit suitable control signals based on those processes. The call control unit 220 accesses various information items stored in the memory 240 when performing a call control operation.

The memory 240 includes a UE Context storage area 241, and UE Context management information 242.

The UE Context storage area 241 is an area for storing, for each UE, a UE Context, which is information necessary for communication with the UE 100, in which there are areas corresponding to a plurality of UEs (N areas in FIG. 4) according to the cell radius, etc. Examples of information elements for each UE to be stored into the UE Context storage area 241 include a UE number, a call state, a resource of a radio section allocated to a UE (hereinafter referred to as a UL individual resource), and information which has been transmitted/received in the past. The size of the area corresponding to one UE in the UE Context storage area 241 is, for example, approximately 50 kilobytes.

The UE Context management information 242 is information for managing the use state of the UE Context storage area 241. Since the UE Context is information necessary for communication with the UE, the eNB 200 performs, upon accepting transmission from the UE, occlusion management in which the eNB 200 allocates an area for the UE in the UE Context storage area 241 by using the UE Context management information 242 and does not release the allocated area until the communication is completed.

### [Operation]

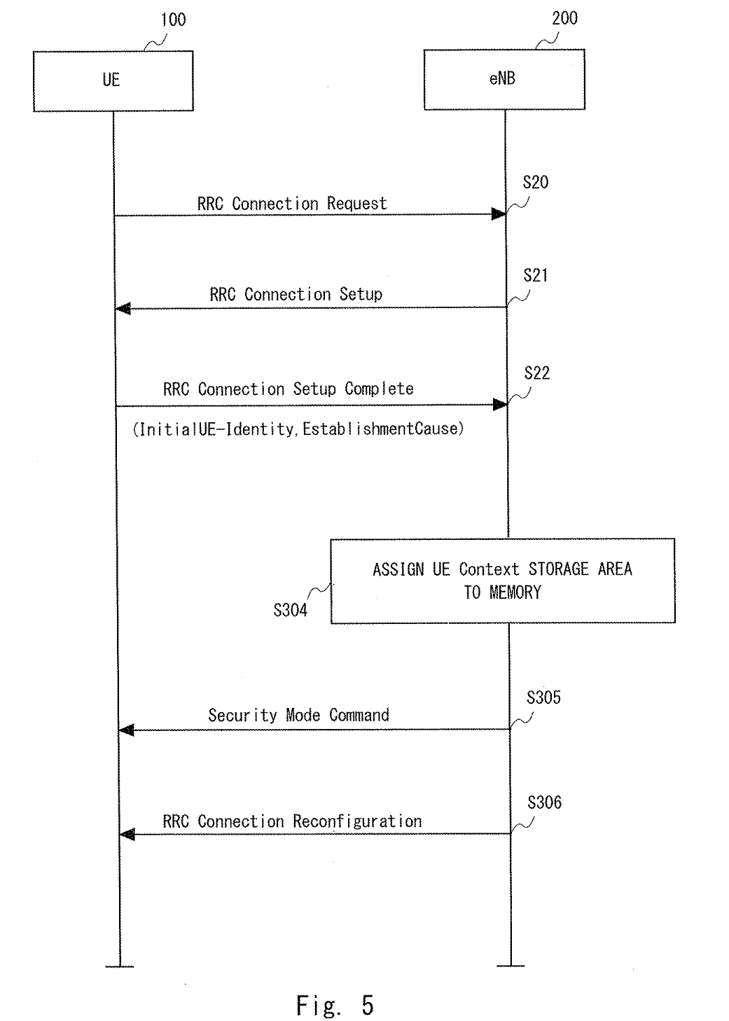

FIG. 5 is a sequence diagram showing an example of an operation according to the second exemplary embodiment. The operation performed by the UE 100 and the eNB 200 will be described hereinafter with reference to FIG. 5.

In a step S301, the UE 100 transmits an RRC Connection Request message, which is a radio control connection request signal, to the eNB 200. The details of the RRC Connection Request are described in Non Patent Literature 1. It is to be noted that, in accordance with Non Patent Literature 1, InitialUE-Identity, which is identification information for a mobile station, and an information element of EstablishmentCause, which is information of connection setup factor, are included in an RRC Connection Request.

In a step S302, the eNB 200 transmits an RRC Connection Setup message, which is a radio control connection setup signal, to the UE 100. The details of the RRC Connection Setup are described in Non Patent Literature 1.

As described above, in the invention according to this exemplary embodiment, no UE Context storage area is allocated in the memory between the step S301 and the step S302. Information elements of InitialUE-Identity and EstablishmentCause are information elements necessary for communication between the eNB 200 and a node of the core network. Accordingly, under normal circumstances, the eNB 200 desirably allocates, in the memory, a UE Context storage area in which these information elements can be stored after the step S301.

Moreover, it is desirable to determine, after the step S301, UL individual resources that need to be notified to the UE by using an RRC Connection Setup message and to store them into the UL Context storage area. However, in the present invention according to this exemplary embodiment, for the purpose of protection against the DoS attacks, no UE Context storage area is allocated in the memory between the steps S301 and S302. Accordingly, in the invention according to this exemplary embodiment, the eNB 200 transmits an RRC Connection Setup message in which no UL individual resource is set.

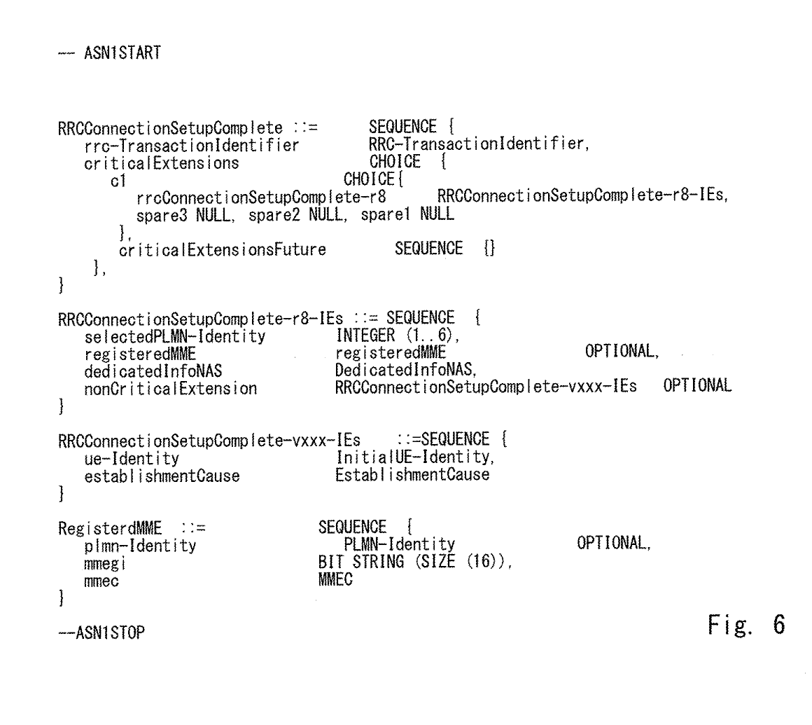

In a step S303, the UE 100 transmits an RRC Connection Setup Complete message, which is the radio control connection setup complete signal, to the eNB 200. The details of the RRC Connection Setup Complete are described in Non Patent Literature 1. In the invention according to this exemplary embodiment, as shown in FIG. 6, it is proposed to add InitialUE-Identity and EstablishmentCause, which are not described in Non Patent Literature 1, to the information elements of the RRC Connection Setup Complete. It is to be noted that, as described above, in the step S302, the eNB 200 has transmitted the RRC Connection Setup message in which no UL individual resource is set to the UE 100. For this reason, in the step S303, the UE 100 transmits the RRC Connection Setup Complete using the Random Access procedure to the eNB 200.

In a step S304, the eNB 200 determines at this point that the UE 100 is not a malicious user who makes DoS attacks and thus allocates an area for the concerned UE in the UE Context storage area 241 by referring to UE Context management information 242. Moreover, after the allocation, the eNB 200 updates the UE Context management information 242.

In a step S305, the eNB 200 transmits a Security Mode Command message to the UE 100. Moreover, in a step S306, the eNB 200 transmits an RRC Connection Reconfiguration message to the UE 100. Since these operations are well known by those skilled in the art, their descriptions will be omitted.

### [Advantageous Effects]

As described above, the eNB according to the second exemplary embodiment allocates, after receiving RRC Connection Setup Complete, an area for storing the UE Context in the memory. By employing such a procedure, even in the case where the eNB receives DoS attacks in which a malicious UE transmits a large amount of RRC Connection Requests but does not respond to the RRC Connection Setup, the storage area for the UE Context will not be depleted and hence the eNB can continue services including a call control operation.

While the present invention has been described in concrete terms based on the preferred exemplary embodiments, needless to say, the present invention is not limited to the above-described exemplary embodiments and various modifications can be made without departing from the scope and spirit of the present invention.

While the present invention is applied to, for example, the mobile communication system of LTE illustrated in FIG. 3 in the second exemplary embodiment, the present invention may be applied to a mobile communication system of 3G (Third Generation).

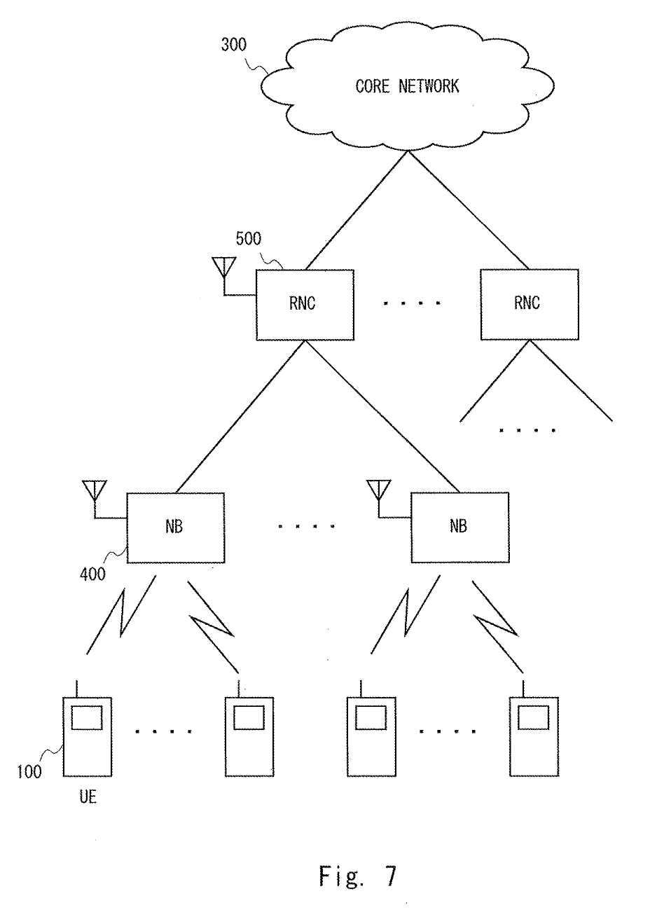

FIG. 7 is a diagram illustrating a configuration of a mobile communication system of 3G specified by 3GPP. The mobile communication system includes UEs 100, NBs (Node B) 400, RNCs (Radio Network Controllers) 500, and a core network 300. As described above, the configuration and the operation in the case where the present invention is applied to the mobile communication system of 3G can be explained by replacing the eNB 200 by the RNC 500 in FIGS. 4 and 5 in the second exemplary embodiment.

This application is based upon and claims the benefit of priority from Japanese patent application No. 2012-215353, filed on Sep. 28, 2012, the disclosure of which is incorporated herein in its entirety by reference.

### REFERENCE SIGNS LIST

10 MOBILE STATION
11 SECOND TRANSMITTING UNIT
12 THIRD RECEIVING UNIT
13 THIRD TRANSMITTING UNIT
20 RADIO ACCESS NETWORK APPARATUS
21 FIRST RECEIVING UNIT
22 FIRST TRANSMITTING UNIT
24 MEMORY
25 ALLOCATING UNIT
100 UE
110 NORMAL UE
120 MALICIOUS UE
200 eNB
210 SIGNAL RECEIVING UNIT
220 CALL CONTROL UNIT
230 SIGNAL TRANSMITTING UNIT
240 MEMORY
241 UE Context STORAGE AREA
242 UE Context MANAGEMENT INFORMATION
300 CORE NETWORK
400 NB
500 RNC

1. A radio access network apparatus comprising:
first receiving unit that receives a radio control connection setup request signal transmitted by a mobile station that establishes a radio control connection;
first transmitting unit that transmits a radio control connection setup signal to the mobile station, which has transmitted the radio control connection setup request signal;
second receiving unit that receives a radio control connection setup complete signal transmitted by the mobile station, which has received the radio control connection setup signal; and
allocating unit that allocates, in a memory, a storage area for storing therein context information necessary for communication with the mobile station upon receiving the radio control connection setup complete signal.

2. The radio access network apparatus according to claim 1,
wherein the radio control connection setup complete signal includes identify information of the mobile station and connection setup factor information of the mobile station.

3. The radio access network apparatus according to claim 2, wherein
the mobile station is a UE (User Equipment),
the radio access network apparatus is an eNB (evolved node B),
the radio control connection request signal is an RRC Connection Request message,
the radio control connection setup signal is an RRC Connection Setup message, and
the radio control connection setup signal is an RRC Connection Setup Complete message.

4. The radio access network apparatus according to claim 2, wherein
the mobile station is a UE (User Equipment), the radio access network apparatus is a RNC (Radio Network Controller),
the radio control connection request signal is an RRC Connection Request message,
the radio control connection setup signal is an RRC Connection Setup message, and
the radio control connection setup complete signal is an RRC Connection Setup Complete message.

5. The radio access network apparatus according to claim 3, Wherein
the identify information for the mobile station is Initial UE-Identity, and
the information for the connection setup factor is Establishment Cause.

6. A communication method comprising:
receiving a radio control connection setup request signal transmitted by a mobile station that establishes a radio control connection between the mobile station and a radio access network apparatus;
transmitting a radio control connection setup signal to the mobile station, which has transmitted the radio control connection setup request signal;
receiving a radio control connection setup complete signal transmitted by the mobile station, which has received the radio control connection setup signal; and
allocating, in a memory, a storage area for storing therein context information necessary for communication with the mobile station upon receiving the radio control connection setup complete signal.

7. A non-transitory computer readable medium storing a program that causes a computer to execute:
a process of receiving a radio control connection setup request signal transmitted by a mobile station;
a process of transmitting a radio control connection setup signal to the mobile station, which has transmitted the radio control connection setup request signal;
a process of receiving a radio control connection setup complete signal transmitted by the mobile station, which has received the radio control connection setup signal, and
a process of allocating, in a memory, a storage area for storing context information necessary for communication with the mobile station upon receiving the radio control connection setup signal.

8. A mobile communication system comprising:
a mobile station; and
a radio access network apparatus that establishes a radio control connection between the radio access network apparatus and the mobile station,
the radio access network apparatus comprising:
first receiving unit that receives a radio control connection setup request signal transmitted by the mobile station;
first transmitting unit that transmits a radio control connection setup signal to the mobile station, which has transmitted the radio control connection setup request signal;
second receiving unit that receives a radio control connection setup complete signal transmitted by the mobile station, which has received the radio control connection setup signal, and
allocating unit that allocates, in a memory, a storage area for storing therein context information necessary for communication with the mobile station upon receiving the radio control connection setup complete signal,
the mobile station comprising:
second transmitting unit that transmits the radio control connection setup request signal to the radio access network apparatus;
third receiving unit that receives the radio control connection setup signal from the radio access network apparatus, and
third transmitting unit that transmits the radio control connection setup complete signal to the radio access network apparatus.

9. A communication method performed by a mobile communication system comprising a mobile station, and a radio access network apparatus that establishes a radio control connection between the radio access network apparatus and the user station, Wherein
the mobile station transmitting a radio control connection setup signal to the radio access network apparatus,
the radio access network apparatus transmitting a radio control connection setup signal to the mobile station, which has transmitted the radio control connection setup request signal,
the mobile station, which has received the radio control connection setup signal, transmitting a radio control connection setup complete signal to the radio access network apparatus, and
the radio access network apparatus, which has received the radio control connection setup complete signal, allocating, in a memory, a storage area for storing therein context information necessary for communication with the mobile station.

10. The radio access network apparatus according to claim 4, wherein
the identify information for the mobile station is Initial UE-Identity, and
the information for the connection setup factor is Establishment Cause.
